(19) United States
(12) Patent Application Publication
(10) Pub. No.: US 2026/0087120 A1
(43) Pub. Date: Mar. 26, 2026

(54) AUTHENTICATING A USER USING DATA FROM ONE OR MORE DEVICES

(71) Applicant: Apple Inc., Cupertino, CA (US)

(72) Inventor: Jessica TRINH, Oakland, CA (US)

(21) Appl. No.: 19/290,868

(22) Filed: Aug. 5, 2025

Related U.S. Application Data
(60) Provisional application No. 63/697,365, filed on Sep. 20, 2024.

(51) Int. Cl. G06F 21/35; G06F 3/01; G06F 3/0346

(52) U.S. Cl. CPC G06F 21/35; G06F 3/011; G06F 3/0346

(57) ABSTRACT

Some examples of the disclosure are directed to systems and methods for authenticating a user of first device using data from one or more devices (optionally including data from a device separate from the first device). The first device transitions from a locked mode to an unlocked mode once the user has been authenticated. In some examples, while the first electronic device is in a locked mode, the first electronic device detects an input to unlock the first electronic device. In some examples, when a second electronic device in communication with the first electronic device has data from the one or more second input devices that satisfies one or more criteria, the first electronic device transitions from the locked mode to the unlocked mode.

### CROSS-REFERENCE TO RELATED APPLICATIONS

This application claims the benefit of U.S. Provisional Application No. 63/697,365, filed Sep. 20, 2024, the content of which is herein incorporated by reference in its entirety for all purposes.

### FIELD OF THE DISCLOSURE

This relates generally to systems and methods for authenticating a user using data from one or more devices.

### BACKGROUND OF THE DISCLOSURE

Some electronic devices require authentication to provide access to of the electronic device. In some examples, the electronic device uses data input via one or more input devices, such as a passcode, to authenticate a user of the electronic device.

### SUMMARY OF THE DISCLOSURE

Some examples of the disclosure are directed to systems and methods for authenticating a first device using data from one or more devices (optionally including data from a device separate from the first device), and more particularly to authenticating a first device using sensor data, including from the one or more separate devices, to authenticate the user of the first device. The first device transitions from a locked mode to an unlocked mode once the user has been authenticated. In some examples, while the first electronic device is in a locked mode, the first electronic device detects an input to unlock the first electronic device. In some examples, when a second electronic device in communication with the first electronic device has data from the one or more second input devices that satisfies one or more criteria, the first electronic device transitions from the locked mode to the unlocked mode.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrates a block diagram of an example architecture for a device according to some examples of the disclosure.

FIGS. 3A-3F illustrate systems and methods for authenticating a user of a first electronic device using data from one or more other devices to transition the first electronic device from a locked mode to an unlocked mode according to some examples of the disclosure.

FIG. 4 is a flowchart describing the method of determining when to transition from a locked mode to an unlocked mode according to some examples of the disclosure.

FIG. 5 illustrates a flow diagram illustrating an example process for transitioning from a locked mode to an unlocked mode according to some examples of the disclosure.

### DETAILED DESCRIPTION

Some examples of the disclosure are directed to systems and methods for authenticating a first device using data from one or more devices (optionally including data from a device separate from the first device), and more particularly to authenticating a first device using sensor data, including from the one or more separate devices, to authenticate the user of the first device. The first device transitions from a locked mode to an unlocked mode once the user has been authenticated. In some examples, while the first electronic device is in a locked mode, the first electronic device detects an input to unlock the first electronic device. In some examples, when a second electronic device in communication with the first electronic device has data from the one or more second input devices that satisfies one or more criteria, the first electronic device transitions from the locked mode to the unlocked mode.

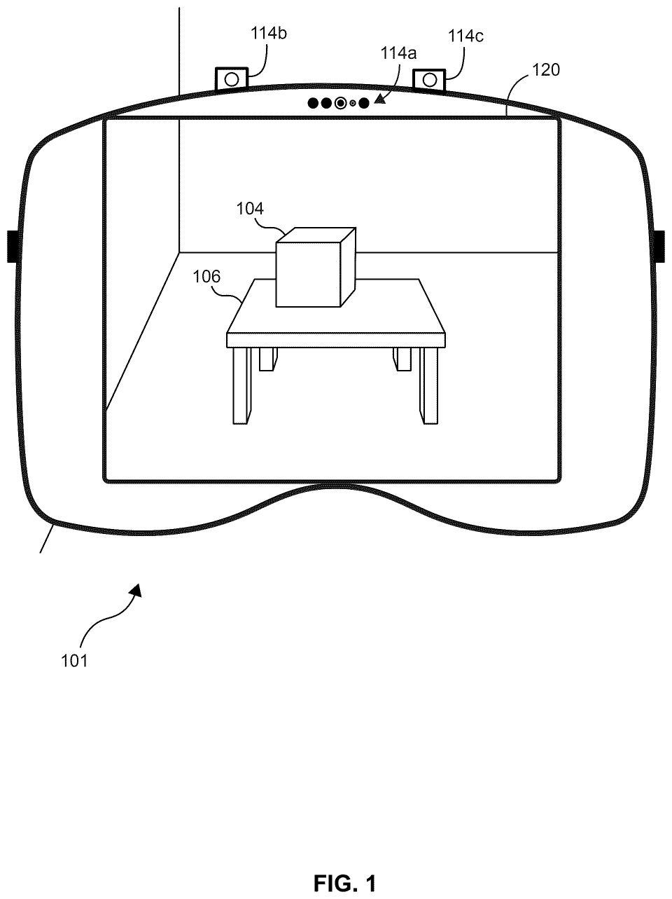

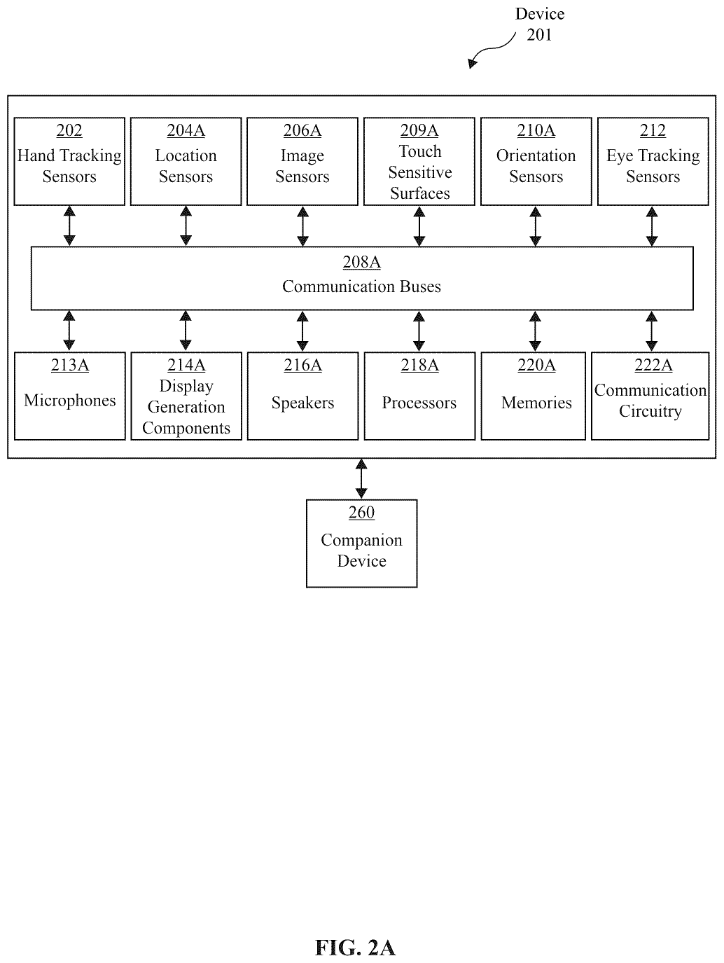

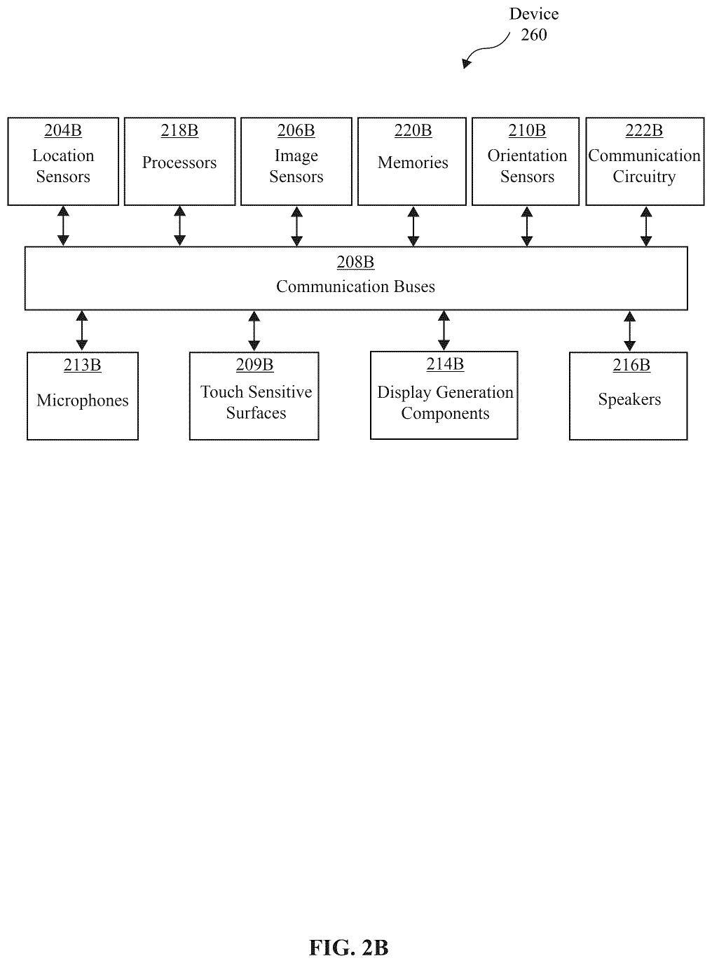

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic devices 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards using data from one or more devices (e.g., such as the electronic device 260) to authenticate and unlock the first electronic device (e.g., corresponding to electronic device 201). As discussed below, the first electronic device may be in communication with the second electronic device. In some examples, the first electronic device and the second electronic device passively and/or actively capture data relating to the electronic devices (e.g., position data, inertial measurement unit data, orientation data, and other data) to be used to authenticate the user of the first electronic device. In some examples, the authentication is performed in response to a request to transition the first electronic device from a locked mode to an unlocked mode. In some examples, the first electronic device uses data from the one or more first input devices of the first electronic device to authenticate the user. In some examples, the first electronic device uses data from the one or more first input devices of the first electronic device and data from one or more second input devices of the second electronic device to authenticate the user. Using data from the first electronic device and/or the second electronic device to automatically unlock the first electronic device reduces the number of inputs needed to unlock the first electronic device, thereby reducing erroneous inputs to the first electronic device. Additionally, using IMU or other motion data to authenticate a user instead of (or before) using camera biometrics authorization reduces the power needed by the electronic device to authenticate the user thereby improving battery life.

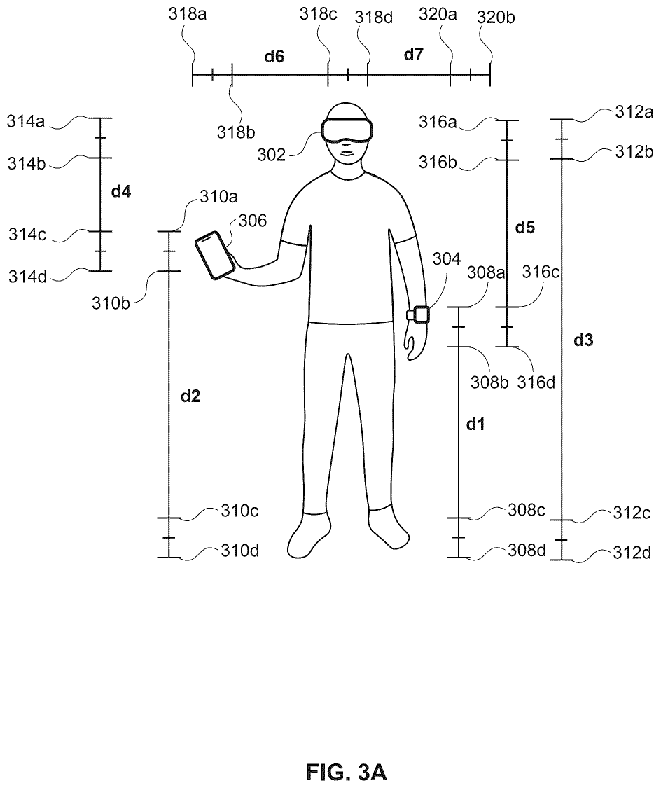

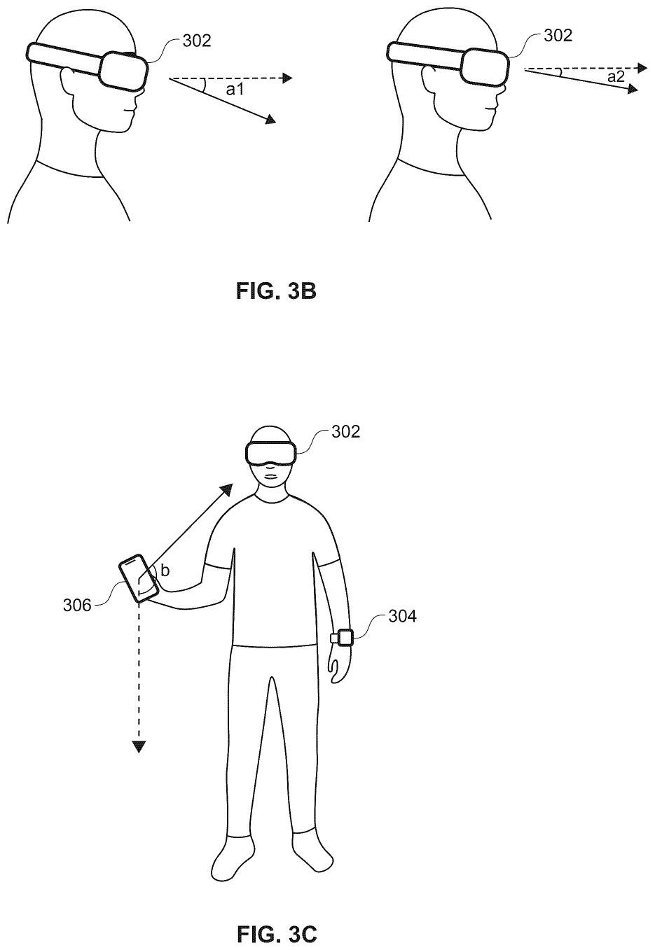

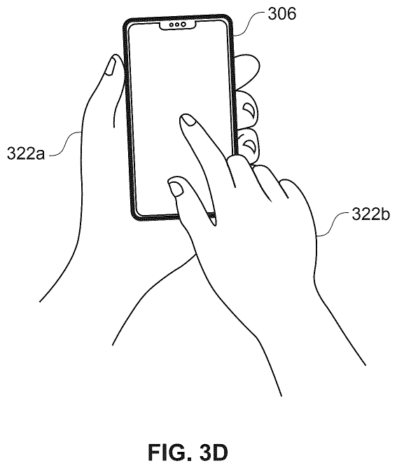

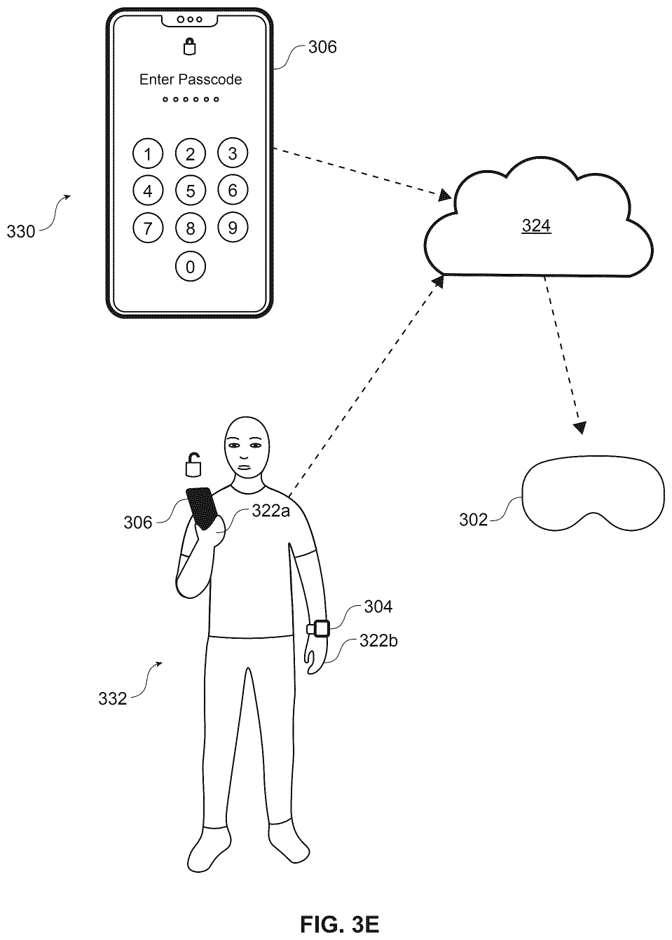

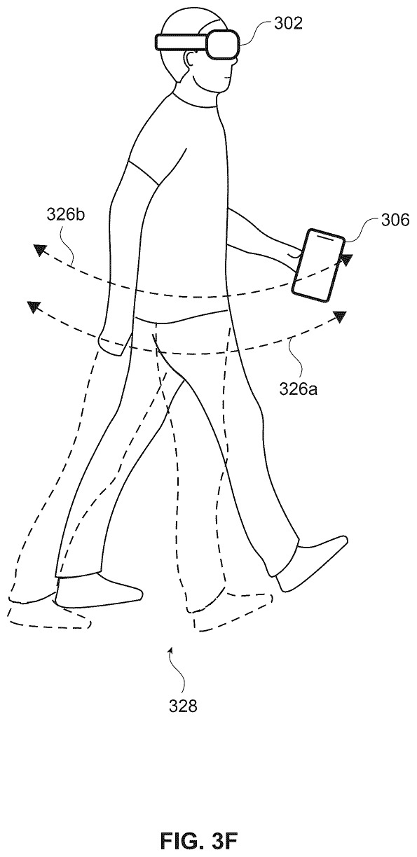

FIGS. 3A-3F illustrate systems and methods for authenticating a user of a first electronic device using data from one or more other devices to transition the first electronic device from a locked mode to an unlocked mode according to some examples of the disclosure. In some examples, the electronic device 302 transitions from a locked mode to an unlocked mode when one or more criteria are satisfied. In some examples, the one or more criteria are satisfied when the one or more measurements taken from the first electronic device and/or the other electronic devices, described below, are satisfied. In some examples, the electronic device 302 enters the unlocked mode when measurements taken at one or more devices (e.g., electronic device 302, 304, and/or 306) match predetermined baseline measurements associated with an authorized user of the devices (e.g., electronic device 302, 304, and 306). In some examples, a locked mode includes a whole-device lock and/or an application-lock. For example, while in the locked mode, the electronic device 302 does not display content on the device (e.g., application data, personal data stored on the electronic device, or other protected data), or the content of the respective applications (e.g., protected data of an application while data from other applications are accessible on the electronic device 302). In some examples, while in the locked mode, the electronic device 302 displays less or different data. For example, the electronic device 302 has restricted functionality during the locked mode (e.g., can receive calls but cannot transmit calls). In some examples, an unlocked mode is a mode in which the electronic device 302 displays the contents (e.g., the previously protected data) of the electronic device and/or of the respective application, or when the previously restricted functionality is no longer restricted.

FIG. 3A illustrates a first electronic device 302, a second electronic device 304, and a third electronic device 306. The first electronic device 302, the second electronic device 304, and the third electronic device 306 may be similar to electronic devices 101 and/or 201/260. In some examples, the first electronic device 302, the second electronic device 304, and the third electronic device 306 may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In some examples, the first electronic device 302, the second electronic device 304, and the third electronic device 306 may be a smart watch, smart phone, smart ring, tablet, and/or laptop. In some examples, the first electronic device 302, the second electronic device 304, and the third electronic device 306 are in communication with each other. For example, they may be in wireless (e.g., Bluetooth, WiFi, and/or wireless network) communication or in a wired (e.g., via wires and/or cables, such as universal serial bus A (USB-A), universal serial bus C (USB-C), and/or ethernet) communication. In some examples, first electronic device 302, the second electronic device 304, and the third electronic device 306 share a common user account and/or a user (e.g., a common user/account uses the devices). For example, a user is optionally logged into one or more electronic devices using one user account (e.g., one username and password).

In one or more examples, the distances between the devices can be used to authenticate a user on a first device. FIG. 3A illustrates the one or more distances that may be used to authenticate a user of the first electronic device 302, and transition the first electronic device 302 from a locked mode to an unlocked mode. In some examples, authenticating a user of the first electronic device 302 includes verifying that the request to unlock the first electronic device 302 is from a user that is associated with the first electronic device 302 (e.g., the owner of the first electronic device 302). In some examples, the first electronic device 302 uses one or more distances (e.g., d1, d2, d3, d4, d5, d6, d7 in FIG. 3A) between devices and/or between a respective device and another object or reference point or a combination of the one or more distances to authenticate the user of the first electronic device 302. For example, using a combination of measurements corresponding to the one or more distances, the first electronic device 302 may authenticate the user requesting to unlock the first electronic device 302, thereby verifying that the user is the owner of the first electronic device 302 and/or is authorized to unlock the first electronic device 302. In some examples, one or more electronic devices 302, 304 and/or 306 determine the distances (e.g., d1 through d7) using one or more input devices, as described below. In some examples, the known distances include a vertical distance from the first electronic device 302 to the ground (d3), a vertical distance from the second electronic device 304 to the ground (d1), a vertical distance from the third electronic device 306 to the ground (d2), a vertical distance from the first electronic device 302 to the second electronic device 304 (d5), a vertical distance from the first electronic device 302 to the third electronic device 306 (d4), a horizontal distance from the first electronic device 302 to the third electronic device 306 (d6), and a horizontal distance from the first electronic device 302 to the second electronic device 304 (d7). In some examples, the known distances may include a combination of the one or more distances (d1 through d7) to identify a user of the electronic device 302. In some examples, the first electronic device 302 may extrapolate a diagonal distance (or otherwise measure non-horizontal or non-vertical distances) between any of the electronic devices 302, 304, and 306. For example, the electronic device 302 may extrapolate a diagonal distance between the first electronic device 302 and the second electronic device 304 using d5 and d7, and a diagonal distance between the first electronic device 302 and the third electronic device 306 using d4 and d6.

In some examples, the electronic device 302 compares the detected measurements (e.g., d1 through d7) to respective baseline measurements for d1 through d7. In some examples, the electronic device 302, 304, and/or 306 establishes the baseline distances by monitoring user (e.g., an authenticated user) behavior over time. In some examples, the electronic devices 302, 304, and/or 306 may monitor user behavior over time to determine contextual scenarios with relevant measurements (e.g., measurement d3 when the user is sitting and when the user is standing, measurement d1 when the user is driving and when the user is walking, measurement d4 when the user is sitting and when the user is standing, or other measurements). In some examples, the electronic device 302 averages the one or more measurements over time to determine the baseline measurement. In some examples, the electronic device 302 may receive one or more baseline measurements from the user (e.g., the user inputs one or more measurements to be used as a baseline).

FIG. 3A also illustrates one or more representations of tolerance margins (e.g., 308a through 308d, 310a through 310d, 312a through 312d, 314a through 314d, 318a through 318d, and 320a through 320b) that illustrate thresholds of recorded measurements for a respective distance d1 through d7 associated with authenticating a user. In some examples, the data captured relating to the distances may not be exact (e.g., the electronic devices 302, 304, and/or 306 are not static when worn or in use by the user because the user may be moving and may not be completely still), therefore the electronic device 302 may associate one or more distances within the margins with authenticating a user of the electronic device 302. For example, margins 316a and 316b represent the limits for the upper boundary of the distance d5 and 316c and 316d represent the limits for the lower boundary for the distance d5. 308a and 308b represent the limits for the upper boundary for the distance d1 and 308c and 308d represent the limits for the lower boundary for the distance d1. 312a and 312b represent the limits for the upper boundary for the distance d3 and 312c and 312d represent the limits for the lower boundary for the distance d3. 314a and 314b represent the limits for the upper boundary for the distance d4 and 314c and 314d represent the limits for the lower boundary for the distance d4. 310a and 310b represent the limits for the upper boundary for the distance d2 and 310c and 310d represent the limits for the lower boundary for the distance d2. 318a and 318b represent the limits for the upper boundary for the distance d6 and 318c and 318d represent the limits for the lower boundary for the distance d6. 318c and 318d also represent the limits for the upper boundary for the distance d7 and 320a and 320b represent the limits for the lower boundary for the distance d7. In some examples, the data relating to the one or more margins are stored on the first electronic device 302.

In some examples, the electronic device 302 authenticates a user by calculating an average of one or more measurements corresponding to distance d1 through d7, or a subset of these measurements. In some examples, when the average of the one or more measurements is within a threshold acceptable measurement to authenticate the user, the electronic device 302 transitions to an unlocked mode. For example, when the average of a measurement of the first electronic device 302 to the ground and a measurement of the second electronic device 304 to the ground is within a ±0.1%, ±1%, ±5%, ±10%, ±15% margin of error from the average of distance d1 and d3, then the measurement is within the threshold acceptable measurement. In some examples, the electronic device 302 may use an artificial intelligence and/or machine learning model (e.g., implemented as hardware or using hardware to implement software and/or firmware including the model) to authenticate the user based on the one or more measurements. For example, the electronic device 302 may use a training model including previous measurements corresponding to the one or more measurements to determine whether the current measurements corresponding to the one or more measurements is within the threshold acceptable measurement to authenticate the user. In some examples, the currently recorded measurements are the input to the model and the probability that the input measurements correspond to the user is the output. In some examples, if the probability exceeds a threshold probability then the electronic device 302 authenticates the user. In some examples, the probability that the input measurements correspond to the user is based on one or more measurements over a threshold period of time (e.g., 1 second, 5 second, 10 seconds, 1 minute, or 5 minutes). In some examples, the probability that the input measurements correspond to the user is based on the number of one or more measurements being within the margins.

In some examples, the electronic device 302 uses one or more image sensors (image sensors 206A and/or 206B), orientation sensors (e.g., orientation sensors 210A and/or 210B), and/or location sensors (e.g., location sensors 204A and/or 204B) to determine the one or more distance measurements. In some examples, the electronic device 302 receives data from one or more sensors on the second electronic device 304 and/or the third electronic device 306. For example, the electronic device 302 uses the image sensors to capture one or more images of the user's environment (e.g., including images of the other electronic device 304 and/or 306 relative to the location of electronic device 302). The electronic device 302 may use the one or more images in conjunction with orientation and/or locations sensors to determine a relative position of a flat surface from the one or more images, and then determine locations of other objects in the one or more images (e.g., the electronic device 304 and/or 306) by using sensor data and/or mathematical equations (e.g., triangulation, ranging, trigonometry and other formulas). In some examples, the electronic devices use Light Detection and Ranging (LIDAR) sensors to determine distances.

Although FIG. 3A illustrates three electronic devices, any number of electronic devices may be used, and the electronic device 302 may use one or more distances relating to one or all of the electronic devices to authenticate the user. In some examples, the electronic device 302 uses more than one measurement to authenticate the user because using more measurements allows the electronic device 302 to detect a more unique combination of measurements (e.g., based on different device placements) and thereby reducing the number of false authorizations. In some examples, the electronic device 302 may be in communication with a fourth electronic device and may use one or more distances relating to the fourth electronic device to authenticate the user additionally or alternatively to using one or more of distances d1 through d7. In some examples, the electronic device 302 is only in communication with a second electronic device and uses one or more distances relating to the second electronic device to authentical the user.

FIG. 3B illustrates a second measurement type that may be used to authenticate a user according to examples of the disclosure. FIG. 3B illustrates an angle a1 and an angle a2, which corresponds to an angle (e.g., an orientation) of the first electronic device 302 while in use. For example, a user may have a low nose bridge and may position the electronic device 302 such that the angle is a larger angle (e.g., angle a1) than a user that has a higher nose bridge (e.g., angle a2). For instance, the angles a1 and a2 are angles of the electronic device 302 that is normal to the horizon. In some examples, the electronic device 302 uses a position sensor, orientation sensor, and/or one or more image sensors to get position and/or orientation data to measure the angle (e.g., a1 or a2). In some examples, the electronic device 302 may be positioned differently based on a head shape of a user's head or nose and/or their preferences. For example, the first electronic device 302 is a headset and a user of the electronic device 302 may position the electronic device 302 on their head in a specific orientation relative to the horizon. For example, a user may position the electronic device 302 at an angle (e.g., tilted up, down, left, and/or right) relative to the horizon. In some examples, the angle at which the user positions the electronic device 302 can be based on physical characteristics of the user (e.g., nose bridge height, check bone structure, head size, head shape, or other characteristics of the user's face). In some examples, the electronic device 302 may transition to an unlocked mode when the electronic device 302 detects that the orientation of the electronic device 302 on the user's head corresponds to a known orientation associated with the user, thereby verifying that the person using the electronic device 302 is an authorized user. In some examples, the measurement shown in FIG. 3B may be combined with one or more measurements, as described above, to be used to authenticate a user.

As used herein, “in use” refers to when the respective electronic device is being used by a user. For example, the respective electronic device (e.g., electronic device 302, 304, and/or 306) includes an active display (e.g., the touch screen is turned on and is not in sleep mode), the respective device is receiving one or more inputs (e.g., from a user), and/or the respective electronic device is actively using one or more input device (e.g., the respective electronic device is playing music (and the screen may be off)).

FIG. 3C illustrates a third measurement type that may be used to authenticate the user of the first electronic device. FIG. 3C illustrates an angle b, which corresponds to the angle of the third electronic device 306 relative to the first electronic device 302 while the third electronic device 306 is in use. For instance, the angle b is the angle between a first vector that originates at third electronic device 306 and points toward electronic device 302 and a second vector that originates at third electronic device 306 and is parallel to gravity. In some examples, the third electronic device 306 is in use when electronic device 302 and/or 306 has detected one or more inputs directed towards the third electronic device 306 within a threshold period of time (e.g., 1, 5, 10, 30, or 60 seconds). In some examples, the third electronic device 306 is in use when a display of the third electronic device 306 is active and/or the first electronic device 302 detects a gaze directed towards the third electronic device 306. In some examples, a user may hold the third electronic device 306 at a specific angle (e.g., angle b) which is specific to the user of the electronic device 302. In some examples, the electronic device 302 may use an angle of the second electronic device 304 relative to the first electronic device 302 when the second electronic device 304 is in use to authenticate the user of the electronic device. In some examples, the electronic device 302 and/or 306 uses one or more position sensors, orientation sensors, and/or one or more image sensors to get position and/or orientation data to determine the angle b. For example, the electronic device 306 may transmit position and/or orientation data relating to the electronic device 306 to electronic device 302. The electronic device 302 may use position and/or orientation data relating to electronic device 302 and 306 to determine the angle b.

FIG. 3D illustrates a fourth measurement that may be used to authenticate the user of the electronic device. In some examples, a user may commonly use a specific finger to interact with one or more elements of the third electronic device 306 while the user is using the third electronic device 306 (e.g., while the third electronic device 306 is “in use”). This common behavior can be used to authenticate the user on a particular device. In FIG. 3D, the user holds the electronic device 306 with hand 322a and interacts with electronic device 306 with fingers of hand 322b, such as the index finger and thumb, for example. In some examples, the electronic device 302 receives data from electronic device 306 indicating which hand and/or finger(s) are interacting with the electronic device 306. For example, the data includes touch sensor data, position data, proximity data, motion and other data from one or more input devices of the electronic device 306 (e.g., touch sensors, location sensors, proximity sensors, motion sensors, or other sensors) to detect the handedness of a user. For example, the one or more sensors (e.g., touch sensors, proximity sensors, and/or location sensors) are able to detect a location of a hand, such as a hand that is holding the electronic device and/or a hand that is being used to interact with the electronic device. In some examples, the user uses two hands (e.g., one to hold the electronic device 306 and one to interact with the electronic device 306), and in some examples, the user uses one hand to hold and interact with the electronic device 306. In some examples, the electronic device 306 uses the touch sensor to determine which finger is being used to interact with the electronic device 306. In some examples, if the handedness data (e.g., data pertaining to which hand of the user interacting with the device) matches previously recorded handedness data of an authorized user interacting with electronic device 306, then the electronic device 302 may transition to an unlocked mode. As described above, the electronic device 302 may use additional data points to authenticate the user. In some examples, the electronic device 302 detects the one or more hands used to interact with the second electronic device 304 and stores the hand (e.g., hand 322b) that an authorized user of the electronic device 302 uses to interact with the second electronic device 304.

FIG. 3E illustrates additional criteria that may be used to evaluate whether to transition the electronic device 302 from a locked mode to an unlocked mode. In some examples, unlocking a device in communication with electronic device 302 causes the electronic device 302 to transition from a locked mode to an unlocked mode. FIG. 3E illustrates a criterion that is satisfied when a device in communication with electronic device 302 (e.g., third electronic device 306 and/or the second electronic device 304) receives a verification key from a user, such as verification key 330 and/or verification key 332 to unlock the respective electronic device. In some examples, verification key 330 is a passcode. In some examples, verification key 332 is a biometric key. For example, electronic device 306 may include a biometric authentication system. In some examples, the verification key 332 is the user's face, fingerprint, voice, or other biometrics. After receiving the verification key 330 and/or 332, the electronic device 306 transmits the indication of the verification key and/or an indication that the electronic device 306 is unlocked to a network 324. In some examples, the network 324 transmits the indication of the verification key to the first electronic device 302. In response to receiving the indication of the verification key, the first electronic device 302 transitions from a locked mode to an unlocked mode.

FIG. 3F illustrates detecting one or more movements that may cause the electronic device 302 to transition from a locked mode to an unlocked mode. In some examples, the electronic device 302, 304 and/or 306 detects one or more movements relating to a user's walking motions using one or more input devices, such as motion sensors, inertial measurement unit (IMU) sensors, position sensors, and/or image sensors, as described above. As shown in FIG. 3F, the electronic device(s) 302, 304 and/or 306 detects arm swings 326a and/or 326b and/or gait 328 while the user is walking. For example, the electronic device 302, 304 and/or 306 may detect an acceleration, velocity, and/or position of the one or more arm swings 326a and/or 326b using one or more sensors in communication with electronic device 302, 304, and/or 306. In some examples, gait 328 is a user's manner of walking. For example, the electronic device 302, 304 and/or 306 may detect stride length, walking cadence, double support time, walking asymmetry, step length, walking speed, and/or other characteristics of gait. In some examples, the electronic device 302, 304, and/or 306 alone or in combination uses one or more motion, location, position sensors such as IMU sensors, accelerometers, and/or gyroscopes to determine gait. In some examples, stride length is a distance between the first contact of the same foot and the next first contact of that foot. In some examples, the electronic devices use acceleration data (e.g., from an accelerometer) and height and weight data (e.g., imputed by a user of the one or more electronic devices 302, 304, and/or 306) to determine stride length. In some examples, walking cadence is a step frequency (e.g., the number of steps taken per minute). In some examples, the electronic device(s) 302, 304, and/or 306 use an accelerometer to determine cadence. In some examples, double support time is an amount of time or a percentage of time that a user is on both feet while walking. In some examples, walking asymmetry is a percent of time that a user's steps with one foot are faster or slower than the other foot. In some examples, step length is a distance between the first contact of one foot and the first contact of the other foot. In some examples, walking speed is a speed (e.g., kilometers per hour, miles per hour, and/or feet per minute) that a user is walking. In some examples, the electronic device(s) 302, 304, and/or 306 use IMU sensor(s) to determine double support time, walking asymmetry, step length, and/or walking speed. The electronic device 302 may use arm swings 326a and/or 326b and/or gait 328 to determine if the user using electronic device 302 is an authorized user to transition the electronic device 302 from the locked mode to the unlocked mode. In some examples, the electronic device 302, 304 and/or 306 captures arm swing data and/or gait data while the respective electronic device is unlocked (e.g., when the user using the respective electronic device is an authorized user). In some examples, the electronic device 302, 304 and/or 306 compares the current arm swing and/or gait data to the previously captured data. In some examples, if the current arm swing and/or gait data is within a threshold margin (e.g., within ±0.1%, ±1%, ±5%, ±10%, ±15% margin of error) of the previously captured data, then the electronic device 302 transitions from a locked mode to an unlocked mode. In some examples, the electronic device 302 uses a machine learning and/or artificial intelligence model (e.g., implemented as hardware or as software/firmware) to determine if the captured data is within the threshold margin of the previously captured data. For example, the electronic device 302 inputs current arm swing and/or gait data to the machine learning and/or artificial intelligence models to receive a probability that the respective data corresponds to an authenticated user.

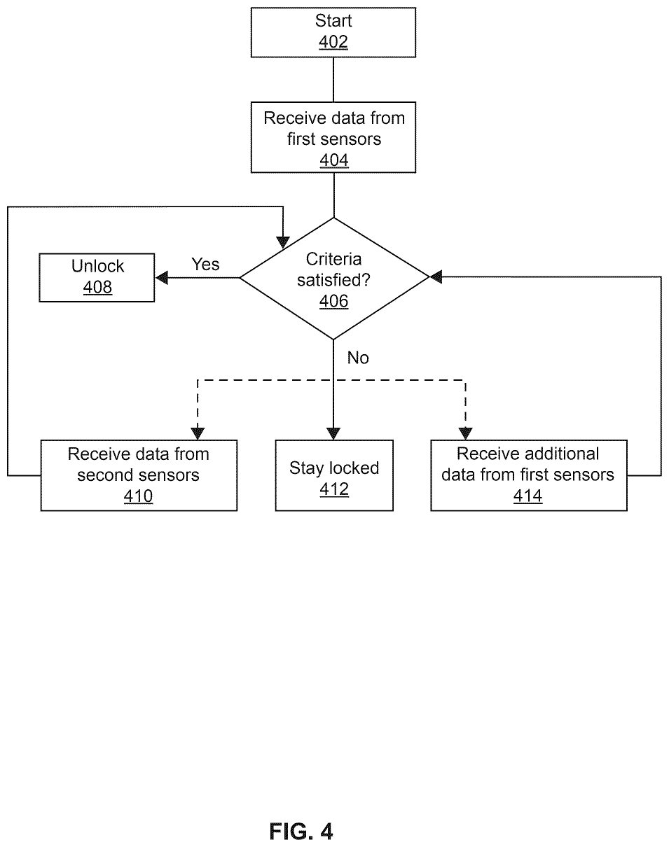

While FIG. 3A-3F describe a plurality of different types of data that may be used to authenticate a user, the electronic device 302 may use a combination of types of data and/or an average of different types of data to determine whether the user is an authorized user. For example, the electronic device 302 may use one or more distances or an average of one or more distances captured from one or more devices described in FIG. 3A to determine whether to transition to an unlocked mode. The electronic device 302 may use an angle of the electronic device 302 and a user's gait 328 to determine whether to transition to an unlocked mode. In some examples, the electronic device 302 may only require one measurement to be within the respective threshold range to authenticate the user. In some examples, the electronic device 302 may require multiple measurements to be within the respective threshold range to authenticate the user. Additional description on satisfying the criteria to authenticate the user is described with reference to FIG. 4.

FIG. 4 illustrates an exemplary process for determining when to transition from a locked mode to an unlocked mode. The process starts at operation 402. At operation 404, the electronic device receives data from a first set of sensors. In some examples, the first set of sensors are sensors included in and/or in communication with the electronic device 302, which are described in greater detail in FIG. 1 and FIG. 2A-2B. In some examples, the first set of sensors include motion sensors, image sensors, location sensors, and/or orientation sensors. At operation 406, if the data from the one or more first sensors satisfy one or more criteria, then the electronic device 302 transitions to an unlocked mode at operation 408. The one or more criteria are described in greater detail below. At operation 406, if the data from the one or more first sensors do not satisfy the criteria, then the electronic device 302 does not transition to the unlocked mode, and remains locked, at operation 412. In some examples, the electronic device 302 receives data from one or more second sensors at operation 410 and/or receives additional data from the one or more first sensors at operation 414. After receiving the additional data from the one or more second sensors and/or the one or more first sensors, the electronic device 302 determines whether the additional data satisfies the one or more criteria to unlock the electronic device 302. In some examples, if the additional data satisfies the one or more criteria, then the electronic device 302 transitions to the unlocked mode, at operation 408.

In some examples, the criteria are satisfied when the data from the first sensors (e.g., sensors located on the electronic device 302) received by the electronic device 302 is within a predetermined threshold range and/or within a predetermined margin of error (±0.1%, ±1%, ±5%, ±10%, ±15% margin of error) for the respective data. For example, the data from the first sensors includes position data of the first electronic device 302 (e.g., angle b, shown in FIG. 3C, and/or distance d3 shown in FIG. 3A). If the angle extrapolated from the first sensors is within a margin of error of the known angle b (e.g., known by previous data captured while the electronic device 302 was unlocked and in use by the authenticated user) and/or if the distance measured (d3) is within a margin of error of the known d3, then the electronic device 302 proceeds to operation 408. If the angle and/or distance is not within the margin of error, then the electronic device 302 proceeds to operation 410 and/or 414, which then loops back to operation 406. In some examples, the electronic device 302 may receive additional data from other electronic devices (e.g., electronic device 304 and/or 306), such as other distance data shown in FIG. 3A, angle data shown in FIG. 3B, hand data shown in FIG. 3D, verification key data shown in FIG. 3E, and/or gait and arm swing data shown in FIG. 3F. In some examples, the electronic device 302 uses the second sensor data which includes data from a combination of devices, instead of data just from electronic device 302. In some examples, data from other devices may provide a more accurate representation of the user requesting the transition to the unlocked mode. In some examples, if the additional data does not satisfy the criteria at operation 406, then the electronic device 302 may remain locked (operation 412). In some examples, if the data from the sensors does not meet the criteria, then the electronic device 302 may request a verification key directly from the user. For example, the electronic device 302 may be unlocked if the electronic device 302 receives a biometric key or a passcode directly from the user on the electronic device 302 (e.g., and not through a network as described in FIG. 3E). In some examples, if the additional data does satisfy the criteria at operation 406, then the electronic device 302 proceeds to operation 408. In some examples, the electronic device 302 first uses sensor data from sensors associated with the electronic device 302 before using sensor data from other devices (e.g., electronic device 304 and/or 306) in communication with the electronic device 302 to reduce the power needed by the electronic device to authenticate the user thereby improving battery life (e.g., it takes more power to receive data and process data from other electronic devices).

In some examples, after receiving data from the first sensors (operation 404), the electronic device 302 determines that the criteria are satisfied (operation 406) when a threshold number of measurements (e.g., 50%, 51%, 80%, 95%, 100% of measurements) from the data from the first sensors is within the margin of error of the respective known measurements. In some examples, if the data from the first sensor(s) does not meet the threshold criteria, then the electronic device 302 proceeds to operation 410 and/or 414. In some examples, after receiving data from the second sensors and/or additional data from the first sensors, if the combination of the data from the first sensors (operation 404), data from the second sensors, and/or additional data from the first sensors satisfy the threshold criteria (e.g., 50%, 51%, 80%, 95%, 100% of measurements are within the margin of error of the respective known measurements), then the electronic device 302 proceeds to operation 408. In some examples, the electronic device 302 uses artificial intelligence and/or machine learning models (e.g., having characteristics of the artificial intelligence and/or machine learning models described above) to determine a probability that the one or more measurements correspond to an authenticated user. For example, the machine learning/artificial intelligence model receives the one or more measurements as an input and outputs the probability.

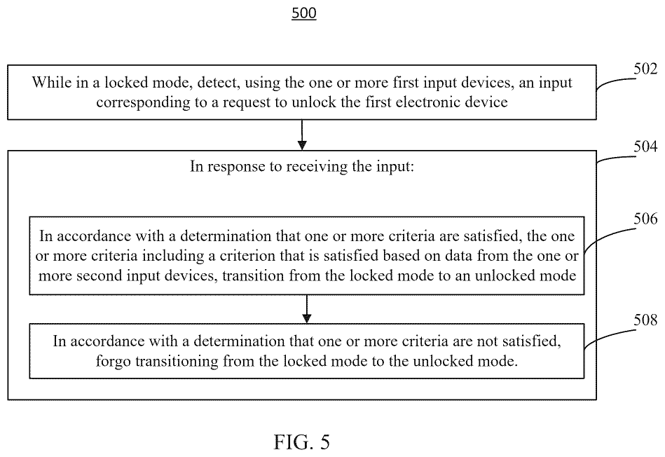

FIG. 5 illustrates a flow diagram illustrating an example process for transitioning from a locked mode to an unlocked mode according to some examples of the disclosure. In some examples, process 500 begins at a first electronic device 302 in communication with one or more first input devices and a second electronic device 304 in communication with one or more displays and one or more second input devices. In some examples, the first electronic device is optionally a head-mounted device similar or corresponding to electronic device 101 of FIG. 1. In some examples, the first and second electronic device correspond to first and/or second electronic device 201 and 260 in FIG. 2A-2B. As shown in FIG. 5, in some examples, at 502, the electronic device detects, using the one or more first input devices, an input corresponding to a request to unlock the first electronic device while the first electronic device is in a locked mode. In some examples, the request to unlock the first electronic device may be a direct or indirect input directed towards the first electronic device 302 such as a tap input, a swipe input, a button click, a voice command, or other inputs. For example, the electronic device 302 may receive an air gaze input directed towards a selectable option to unlock the electronic device 302 or an air gaze input directed towards a representation of an application to unlock/open the application. In some examples, at 504, in response to receiving the input, in accordance with a determination that one or more criteria are satisfied, the one or more criteria including a criterion that is satisfied based on data from the one or more second input devices, the electronic device transitions from the locked mode to an unlocked mode, at 506. In some examples, the data includes distance data shown in FIG. 3A, angle data shown in FIG. 3B-3C, hand data shown in FIG. 3D, verification key data shown in FIG. 3E, and/or gait and arm swing data shown in FIG. 3F. In some examples, if the data is within a threshold margin of error of previously recorded data (e.g., an average of the previously recorded data), then the electronic device 302 transitions to the unlocked mode.

In some examples, at 504, in response to receiving the input, in accordance with a determination that one or more criteria are not satisfied, the electronic device forgoes transitioning from the locked mode to the unlocked mode, at 508. In some examples, the electronic device 302 may request additional data (e.g., from input devices in communication with electronic device 302, 304, and/or 306). In some examples, if the additional data satisfies the one or more criteria, then the electronic device 302 transitions to the unlocked mode. In some examples, if the one or more criteria are not satisfied, then the electronic device 302 remains locked.

It is understood that process 500 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIG. 2A-2B) or application specific chips, and/or by other components of FIG. 2A-2B.

Therefore, according to the above, some examples of the disclosure are directed to a method, comprising at a first electronic device with one or more displays and one or more first input devices and in communication with a second electronic device including one or more second input devices: while in a locked mode, detecting, using the one or more first input devices, an input corresponding to a request to unlock the first electronic device; and in response to receiving the input: in accordance with a determination that one or more criteria are satisfied, the one or more criteria including a criterion that is satisfied based on data from the one or more second input devices and a criterion that is satisfied based on elevation data or orientation data from the one or more first input devices, transitioning from the locked mode to an unlocked mode; and in accordance with a determination that one or more criteria are not satisfied, forgoing transitioning from the locked mode to the unlocked mode. Additionally or alternatively to one of more of the examples disclosed above, in some examples, the one or more criteria include a criterion that is satisfied based on an orientation of the first electronic device relative to a user of the first electronic device while the first electronic device is in use. Additionally or alternatively to one of more of the examples disclosed above, in some examples, the orientation of the first electronic device relative to the user of the first electronic device is determined using one or more motion sensors and orientation sensors associated with the first electronic device. Additionally or alternatively to one of more of the examples disclosed above, in some examples, the one or more criteria include a criterion that is satisfied based on a distance between the first electronic device and the second electronic device. Additionally or alternatively to one of more of the examples disclosed above, in some examples, the one or more criteria include a criterion that is satisfied based on a distance between the first electronic device and a ground. Additionally or alternatively to one of more of the examples disclosed above, in some examples, the one or more criteria include a criterion that is satisfied based on a hand of a user of the first electronic device used to interact with the second electronic device. Additionally or alternatively to one of more of the examples disclosed above, in some examples, the one or more criteria include a second criterion that is satisfied based on a hand of a user of the first electronic device used to interact with the first electronic device. Additionally or alternatively to one of more of the examples disclosed above, in some examples, the data from the one or more second input devices include data corresponding to an orientation of the second electronic device relative to a user of the first electronic device while in use. Additionally or alternatively to one of more of the examples disclosed above, in some examples, the data from the one or more second input devices include position data of the second electronic device relative to the first electronic device. Additionally or alternatively to one of more of the examples disclosed above, in some examples, the data from the one or more second input devices include one or more measurements collected during operation of the second electronic device, and wherein the one or more criteria include a criterion that is satisfied when the one or more measurements is within a threshold range stored on the first electronic device. Additionally or alternatively to one of more of the examples disclosed above, in some examples, the one or more measurements are within the threshold range stored on the first electronic device when an average of the one or more measurements is within the threshold ranges. Additionally or alternatively to one of more of the examples disclosed above, in some examples, the one or more criteria include a criterion that is satisfied when the first electronic device receives a verification key from a user. Additionally or alternatively to one of more of the examples disclosed above, in some examples, the one or more criteria include a criterion that is satisfied based on a motion detected by the one of more first input devices or the one or more second input devices. Additionally or alternatively to one of more of the examples disclosed above, in some examples, the first electronic device is in communication with a third electronic device including one or more third input devices; and the one or more criteria include a criterion that is satisfied based on second data from the one or more third input devices.

Some examples of the disclosure are directed to a method, comprising at a first electronic device with one or more first input devices including an inertial measurement unit: while in a locked mode, detecting, using the one or more first input devices, an input corresponding to a request to transition from the locked mode to an unlocked mode; and in response to receiving the input: in accordance with a determination that one or more first criteria are satisfied, the one or more first criteria including a criterion that is satisfied based on inertial measurement unit data from the one or more first input devices, transitioning from the locked mode to the unlocked mode. Additionally or alternatively to one of more of the examples disclosed above, in some examples, the method further comprises in response to receiving the input: in accordance with a determination that the one or more first criteria are not satisfied based on the inertial measurement unit data from the one or more first input devices, and while in communication with a second electronic device including one or more second input devices: receiving data from the one or more second input devices; and in accordance with a determination that one or more second criteria are satisfied, the one or more second criteria including a criterion that is satisfied based on data from the one or more second input devices, transitioning from the locked mode to the unlocked mode.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's biometric data.

The present disclosure recognizes that the use of such personal information data, in the present technology, can be used to the benefit of users. For example, personal information data may be used to display suggested text that changes based on changes in a user's biometric data. For example, the suggested text is updated based on changes to the user's age, height, weight, and/or health history.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device with one or more displays and one or more first input devices and in communication with a second electronic device including one or more second input devices:
while in a locked mode, detecting, using the one or more first input devices, an input corresponding to a request to unlock the first electronic device; and
in response to receiving the input:
in accordance with a determination that one or more criteria are satisfied, the one or more criteria including a criterion that is satisfied based on data from the one or more second input devices and a criterion that is satisfied based on elevation data or orientation data from the one or more first input devices, transitioning from the locked mode to an unlocked mode; and
in accordance with a determination that one or more criteria are not satisfied, forgoing transitioning from the locked mode to the unlocked mode.

2. The method of claim 1, wherein the one or more criteria include a criterion that is satisfied based on a distance between the first electronic device and the second electronic device.

3. The method of claim 1, wherein the one or more criteria include a criterion that is satisfied based on a distance between the first electronic device and a ground.

4. The method of claim 1, wherein the one or more criteria include a criterion that is satisfied based on a hand of a user of the first electronic device used to interact with the second electronic device and/or a criterion that is satisfied based on a hand of a user of the first electronic device used to interact with the first electronic device.

5. The method of claim 1, wherein the data from the one or more second input devices include at least one of data corresponding to an orientation of the second electronic device relative to a user of the first electronic device while in use, position data of the second electronic device relative to the first electronic device, and/or one or more measurements collected during operation of the second electronic device, wherein the one or more criteria include a criterion that is satisfied when the one or more measurements is within a threshold range stored on the first electronic device.

6. The method of claim 5, wherein the one or more measurements are within the threshold range stored on the first electronic device when an average of the one or more measurements is within the threshold ranges.

7. The method of claim 1, wherein the one or more criteria include a criterion that is satisfied when the first electronic device receives a verification key from a user and/or a criterion that is satisfied based on a motion detected by the one of more first input devices or the one or more second input devices.

8. The method of claim 1, wherein the first electronic device is in communication with a third electronic device including one or more third input devices; and
the one or more criteria include a criterion that is satisfied based on second data from the one or more third input devices.

9. A first electronic device, comprising:
one or more processors;
memory; and
one or more programs, wherein the one or more programs are stored in the memory and configured to be executed by the one or more processors, the one or more programs including instructions for:
while in a locked mode, detecting, using one or more first input devices, an input corresponding to a request to unlock the first electronic device; and
in response to receiving the input:
in accordance with a determination that one or more criteria are satisfied, the one or more criteria including a criterion that is satisfied based on data from one or more second input devices and a criterion that is satisfied based on elevation data or orientation data from the one or more first input devices, transitioning from the locked mode to an unlocked mode; and
in accordance with a determination that one or more criteria are not satisfied, forgoing transitioning from the locked mode to the unlocked mode.

10. The first electronic device of claim 9, wherein the one or more criteria include a criterion that is satisfied based on a distance between the first electronic device and a second electronic device.

11. The first electronic device of claim 9, wherein the one or more criteria include a criterion that is satisfied based on a distance between the first electronic device and a ground.

12. The first electronic device of claim 9, wherein the one or more criteria include a criterion that is satisfied based on a hand of a user of the first electronic device used to interact with a second electronic device and/or a criterion that is satisfied based on a hand of a user of the first electronic device used to interact with the first electronic device.

13. The first electronic device of claim 9, wherein the data from the one or more second input devices include at least one of data corresponding to an orientation of a second electronic device relative to a user of the first electronic device while in use, position data of the second electronic device relative to the first electronic device, and/or one or more measurements collected during operation of the second electronic device, wherein the one or more criteria include a criterion that is satisfied when the one or more measurements is within a threshold range stored on the first electronic device.

14. The first electronic device of claim 13, wherein the one or more measurements are within the threshold range stored on the first electronic device when an average of the one or more measurements is within the threshold ranges.

15. The first electronic device of claim 9, wherein the one or more criteria include a criterion that is satisfied when the first electronic device receives a verification key from a user and/or a criterion that is satisfied based on a motion detected by the one of more first input devices or the one or more second input devices.

16. The first electronic device of claim 9, wherein the first electronic device is in communication with a third electronic device including one or more third input devices; and
the one or more criteria include a criterion that is satisfied based on second data from the one or more third input devices.

17. A non-transitory computer readable storage medium storing one or more programs, the one or more programs comprising instructions, which when executed by one or more processors of a first electronic device, cause the first electronic device to perform a method comprising:
while in a locked mode, detecting, using one or more first input devices, an input corresponding to a request to unlock the first electronic device; and
in response to receiving the input:
in accordance with a determination that one or more criteria are satisfied, the one or more criteria including a criterion that is satisfied based on data from one or more second input devices and a criterion that is satisfied based on elevation data or orientation data from the one or more first input devices, transitioning from the locked mode to an unlocked mode; and
in accordance with a determination that one or more criteria are not satisfied, forgoing transitioning from the locked mode to the unlocked mode.

18. The non-transitory computer readable storage medium of claim 17, wherein the one or more criteria include a criterion that is satisfied based on a distance between the first electronic device and a second electronic device.

19. The non-transitory computer readable storage medium of claim 17, wherein the one or more criteria include a criterion that is satisfied based on a distance between the first electronic device and a ground.

20. The non-transitory computer readable storage medium of claim 17, wherein the one or more criteria include a criterion that is satisfied based on a hand of a user of the first electronic device used to interact with a second electronic device and/or a criterion that is satisfied based on a hand of a user of the first electronic device used to interact with the first electronic device.

21. The non-transitory computer readable storage medium of claim 17, wherein the data from the one or more second input devices include at least one of data corresponding to an orientation of a second electronic device relative to a user of the first electronic device while in use, position data of the second electronic device relative to the first electronic device, and/or one or more measurements collected during operation of the second electronic device, wherein the one or more criteria include a criterion that is satisfied when the one or more measurements is within a threshold range stored on the first electronic device.

22. The non-transitory computer readable storage medium of claim 21, wherein the one or more measurements are within the threshold range stored on the first electronic device when an average of the one or more measurements is within the threshold ranges.

23. The non-transitory computer readable storage medium of claim 17, wherein the one or more criteria include a criterion that is satisfied when the first electronic device receives a verification key from a user and/or a criterion that is satisfied based on a motion detected by the one of more first input devices or the one or more second input devices.

24. The non-transitory computer readable storage medium of claim 17, wherein the first electronic device is in communication with a third electronic device including one or more third input devices; and
the one or more criteria include a criterion that is satisfied based on second data from the one or more third input devices.
